(19) United States
(12) Patent Application Publication
(10) Pub. No.: US 2012/0065322 A1
(43) Pub. Date: Mar. 15, 2012

(54) (METH)ACRYLATE POLYMER, COATING AGENT, METHOD FOR PRODUCING A COATING, AND COATED OBJECT

(75) Inventors: Stefanie Maus, Frankfurt (DE); Christine Maria Breiner, Laudenbach (DE); Cornelia Borgmann, Frankfurt (DE); Ulrike Behrens, Hanau (DE); Oliver Marx, Maintal (DE); Stephan Fengler, Frankfurt (DE)

(73) Assignee: EVONIK ROEHM GmbH, Darmstadt (DE)

(21) Appl. No.: 13/257,178

(22) PCT Filed: Mar. 2, 2010
(86) PCT No.: PCT/EP2010/052585

§ 371 Date: Nov. 28, 2011

(30) Foreign Application Priority Data
Mar. 30, 2009 (DE) 10 2009 001 970.7

(51) Int. Cl. C09D 133/12; C08F 220/58; B05D 3/00; C09D 133/24; B05D 7/24; B05D 7/14; C08F 220/28; C08F 232/08

(52) U.S. Cl. 524/553; 526/318.42; 526/304; 526/281; 524/558; 524/555; 427/385.5; 427/388.1

(57) ABSTRACT

The present invention relates to a (meth)acrylate polymer for preparing a coating composition, where the (meth)acrylate polymer has a weight-average molecular weight in the range from 10 000 to 60 000 g/mol and the (meth)acrylate polymer comprises 0.5 to 40% by weight of units derived from (meth)acrylic monomers which in the alkyl radical have at least one double bond and 8 to 40 carbon atoms, 0.1 to 10% by weight of units derived from monomers containing acid groups, and 50 to 99.4% by weight of units derived from (meth)acrylates having 1 to 12 carbon atoms in the alkyl radical that have no double bonds or heteroatoms in the alkyl radical, and these (meth)acrylates having 1 to 12 carbon atoms in the alkyl radical are selected such that a polymer composed of these (meth)acrylates having 1 to 12 carbon atoms in the alkyl radical has a glass transition temperature of at least 40° C., based in each case on the weight of the (meth)acrylate polymer.

The present invention further relates to a coating material comprising the stated polymer, and to a method of producing a coating. The present invention additionally describes a coated article comprising a coating obtainable by the method.

The present invention relates to a (meth)acrylate polymer and to a coating material that comprises that polymer. The present invention is directed, moreover, to a method of producing a coating, which is carried out using the coating material, and to a coated article obtainable by the method.

Coating materials, paints in particular, have been synthetically produced for a long time. One important group of these materials is based on aqueous dispersions which in many cases comprise meth(acrylate) polymers. For example, the publication DE-A-41 05 134 describes aqueous dispersions comprising alkyl methacrylates as binders. Paints of this kind are known, furthermore, from U.S. Pat. No. 5,750,751, EP-A-1 044 993 and WO 2006/013061.

Aqueous dispersions can be used to produce a large number of coatings and are notable in particular for a high level of environmental friendliness. A disadvantage, however, is that aqueous dispersions must be processed under controlled temperature conditions and humidity conditions, since otherwise the quality of the coatings obtained does not satisfy heightened requirements.

Besides aqueous dispersions, reactive paints form a further group of known coating materials. Paints of this kind are known from EP-0 693 507, for example. These coating materials can be processed in particular to particularly hard and durable coatings. However, the curing conditions must be very precisely observed, since otherwise the paints obtained are not of high quality. Fluctuations in temperature and in humidity rule out the production of a coating having a high quality.

If articles are provided with a coating in the open air, then temperature and humidity fluctuations must be factored in. For these purposes, therefore, it is common to use what are called solvent-borne paints, which, on account of their performance capacity have to date been irreplaceable, especially in the production of protective coatings. This performance capacity encompasses in particular good processing properties on the part of the coating materials, and a high resistance on the part of the coatings obtained. Coating materials of this kind are described in GB 793776, for example. Since their processing entails releasing large amounts of solvent, however, the environment-friendliness of solvent-borne paints is relatively low.

In view of the prior art, then, it is an object of the present invention to provide polymers and coating materials having outstanding properties. These properties include in particular good processing properties over a wide range of temperatures and humidities. The coating material, moreover, ought to have a very high solids content. In relation to the performance capacity, the coating materials ought to exhibit an improved environment-friendliness.

In particular the coating materials ought to have a high solids content.

It was also an object of the present invention, therefore, to provide a coating material which has a particularly long storage life and durability. Moreover, it ought to be possible to vary the hardness of the coatings obtainable from the coating materials, and to do so over a wide range. The possibility of obtaining particularly hard, scratch-resistant coatings ought to be a particular aim. Moreover, coatings obtainable from the coating materials of the invention ought to have a relatively low brittleness relative to their hardness.

A further object is seen as being that of providing polymers which can be used to obtain coating materials having good processing properties. The coatings obtainable from the coating materials ought to exhibit high weathering stability, particularly a high UV resistance.

Moreover, the coatings obtainable from the polymers and coating materials ought to exhibit particularly high resistance with respect to solvents. This stability ought to be high with respect to a large number of different solvents. There ought also to be very good resistance towards water, especially salt water.

A further object can be seen as that of specifying polymers and coating materials which can be obtained very inexpensively and on an industrial scale.

These and other objects which, although not set out explicitly, are nevertheless readily derivable or inferable from the context discussed in the foregoing introduction are achieved by means of a (meth)acrylate polymer having all of the features of claim 1. Advantageous modifications of the (meth)acrylate polymer of the invention are protected in dependent claims. With regard to a coating material, to a method of producing a coating and to a coated article, claims 14, 17 and 19 offer an achievement of the underlying objects.

The present invention accordingly provides a (meth)acrylate polymer for preparing a coating composition, the polymer being characterized in that the (meth)acrylate polymer has a weight-average molecular weight in the range from 10 000 to 60 000 g/mol and the (meth)acrylate polymer comprises 0.5 to 40% by weight of units derived from (meth)acrylic monomers which in the alkyl radical have at least one double bond and 8 to 40 carbon atoms, 0.1 to 10% by weight of units derived from monomers containing acid groups, and 50 to 99.4% by weight of units derived from (meth)acrylates having 1 to 12 carbon atoms in the alkyl radical that have no double bonds or heteroatoms in the alkyl radical, and these (meth)acrylates having 1 to 12 carbon atoms in the alkyl radical are selected such that a polymer composed of these (meth)acrylates having 1 to 12 carbon atoms in the alkyl radical has a glass transition temperature of at least 40° C., based in each case on the weight of the (meth)acrylate polymer.

Through the measures according to the invention it is additionally possible to obtain advantages including the following:

The polymers of the present invention result in a coating material which has good processing properties over a wide range of temperatures and humidities. Furthermore, the coating material can have a very high solids content, without unduly adversely affecting the processing properties of the coating material.

Relative to the performance capacity, the coating materials are very eco-friendly. In particular the coating materials have a high solids content.

The polymers of the present invention, and the coating materials, exhibit a particularly long storage life and durability. Furthermore, the hardness of the coatings obtainable from the coating materials can be varied over a wide range. In particular it is possible to obtain especially hard, scratch-resistance coatings.

Moreover, coatings obtainable from the coating materials of the invention have a relatively low brittleness relative to the hardness and the chemical resistance.

The coatings obtainable from the coating materials display high weathering stability, more particularly a high UV resistance.

In addition, the coatings obtainable from the polymers and coating materials display particularly high resistance towards solvents. This stability is high with respect to a large number of different solvents. There is also very good resistance towards water, especially salt water. Accordingly, these coating materials can be used to produce protective coatings which are suitable, in particular, for the coating of ships or containers.

Furthermore, coating materials of the invention result in coatings having a high gloss. In addition, the polymers and coating materials of the invention are obtainable particularly inexpensively and on an industrial scale.

The (meth)acrylate polymers may be obtained preferably by free-radical polymerization. Accordingly, the weight fraction of the respective units possessed by these polymers is a product of the weight fractions of corresponding monomers that are used in preparing the polymers.

The (meth)acrylate polymer of the invention comprises 0.5 to 40%, preferably 1% to 20% and very preferably 2 to 10% by weight of units derived from (meth)acrylic monomers which in the alkyl radical have at least one double bond and 8 to 40 carbon atoms.

(Meth)acrylic monomers which in the alkyl radical have at least one double bond and 8 to 40 carbon atoms are esters or amides of (meth)acrylic acid whose alkyl radical has at least one carbon-carbon double bond and 8 to 40 carbon atoms. The (meth)acrylic acid notation denotes methacrylic acid and acrylic acid and also mixtures thereof. The alkyl or alcohol or amide radical may have preferably 10 to 30 and more preferably 12 to 20 carbon atoms, and this radical may comprise heteroatoms, especially oxygen, nitrogen or sulphur atoms. The alkyl radical may have one, two, three or more carbon-carbon double bonds. The polymerization conditions under which the polymer is prepared are preferably chosen so as to maximize the proportion of alkyl radical double bonds retained in the polymerization. This can be accomplished, for example, by sterically hindering the double bonds present in the alcohol radical. Moreover, at least some and preferably all of the double bonds present in the alkyl radical of the (meth)acrylic monomer have a lower reactivity in a free-radical polymerization than a (meth)acryloyl group, and so there are preferably no further (meth)acryloyl groups present in the alkyl radical.

The iodine number of the (meth)acrylic monomers to be used for preparing the polymers and having in the alkyl radical at least one double bond and 8 to 40 carbon atoms is preferably at least 40, more preferably at least 80 and very preferably at least 140 g iodine/100 g (meth)acrylic monomer.

(Meth)acrylic monomers of this kind correspond in general to the formula (I)

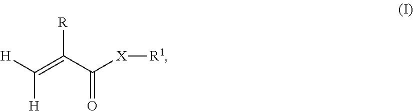

in which the radical R is hydrogen or methyl, X independently is oxygen or a group of the formula NR', in which R′ is hydrogen or a radical having 1 to 6 carbon atoms, and R¹ is a linear or branched radical having 8 to 40, preferably 10 to 30 and more preferably 12 to 20 carbon atoms and having at least one double bond.

(Meth)acrylic monomers which in the alkyl radical have at least one double bond and 8 to 40 carbon atoms may be obtained, for example, by esterification of (meth)acrylic acid, reaction of (meth)acryloyl halides or transesterification of (meth)acrylates with alcohols which have at least one double bond and 8 to 40 carbon atoms. Correspondingly, (meth)acrylamides can be obtained by reaction with an amine. These reactions are set out in, for example, Ullmann's Encyclopedia of Industrial Chemistry, 5th edition on CD-ROM, or F.-B. Chen, G. Bufkin, “Crosslinkable Emulsion Polymers by Autooxidation I”, Journal of Applied Polymer Science, Vol. 30, 4571-4582 (1985).

The alcohols suitable for such reaction include, among others, octenol, nonenol, decenol, undecenol, dodecenol, tridecenol, tetradecenol, pentadecenol, hexadecenol, heptadecenol, octadecenol, nonadecenol, icosenol, docosenol, octadienol, nonadienol, decadienol, undecadienol, dodecadienol, tridecadienol, tetradecadienol, pentadecadienol, hexadecadienol, heptadecadienol, octadecadienol, nonadecadienol, icosadienol and/or docosadienol. These so-called fatty alcohols are in some cases available commercially or can be obtained from fatty acids, this reaction being set out in, for example, F.-B. Chen, G. Bufkin, Journal of Applied Polymer Science, Vol. 30, 4571 -4582 (1985).

The preferred (meth)acrylates obtainable by this process include, in particular, octadienyl(meth)acrylate, octadecadienyl(meth)acrylate, octadecatrienyl(meth)acrylate, hexadecenyl(meth)acrylate, octadecenyl(meth)acrylate and hexadecadienyl(meth)acrylate.

Furthermore, (meth)acrylates which in the alkyl radical have at least one double bond and 8 to 40 carbon atoms can also be obtained by reaction of unsaturated fatty acids with (meth)acrylates which have reactive groups in the alkyl radical, more particularly alcohol radical. The reactive groups include, in particular, hydroxyl groups and also epoxy groups. Use may accordingly be made, for example, among others, of hydroxyalkyl(meth)acrylates, such as 3-hydroxypropyl(meth)acrylate, 3,4-dihydroxybutyl(meth)acrylate, 2-hydroxyethyl(meth)acrylate, 2-hydroxypropyl(meth)acrylate, 2,5-dimethyl-1,6-hexanediol(meth)acrylate, 1,10-decanediol(meth)acrylate; or (meth)acrylates containing epoxy groups, such as glycidyl(meth)acrylate, for example, as reactants for preparing the aforementioned (meth)acrylates.

Suitable fatty acids for reaction with the aforementioned (meth)acrylates are in many cases available commercially and are obtained from natural sources. They include, among others, undecylenic acid, palmitoleic acid, oleic acid, elaidic acid, vaccenic acid, icosenoic acid, cetoleic acid, erucic acid, nervonic acid, linoleic acid, linolenic acid, arachidonic acid, timnodonic acid, clupanodonic acid and/or cervonic acid.

The preferred (meth)acrylates obtainable by this process include, in particular, (meth)acryloyloxy-2-hydroxypropyl-linoleic acid ester, (meth)acryloyloxy-2-hydroxypropyl-linolenic acid ester and (meth)acryloyloxy-2-hydroxypropyl-oleic acid ester.

The reaction of the unsaturated fatty acids with (meth)acrylates which have reactive groups in the alkyl radical, more particularly alcohol radical, is known per se and is set out in, for example, DE-A-41 05 134, DE-A-25 13 516, DE-A-26 38 544 and U.S. Pat. No. 5,750,751.

In one preferred embodiment it is possible to use (meth)acrylic monomers of the general formula (II)

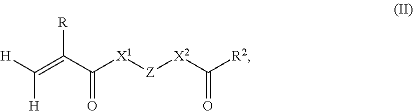

in which R is hydrogen or a methyl group, X¹ and X² independently are oxygen or a group of the formula NR′, in which R′ is hydrogen or a radical having 1 to 6 carbon atoms, with the proviso that at least one of the groups X¹ and X² is a group of the formula NR′, in which R′ is hydrogen or a radical having 1 to 6 carbon atoms, Z is a linking group, and R² is an unsaturated radical having 9 to 25 carbon atoms.

Surprising advantages can be obtained, moreover, through the use of a (meth)acrylic monomer of the general formula (III)

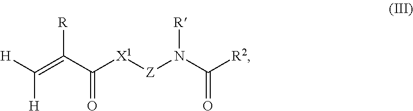

in which R is hydrogen or a methyl group, X¹ is oxygen or a group of the formula NR′, in which R′ is hydrogen or a radical having 1 to 6 carbon atoms, Z is a linking group, a is hydrogen or a radical having 1 to 6 carbon atoms and R² is an unsaturated radical having 9 to 25 carbon atoms.

The expression “radical having 1 to 6 carbon atoms” stands for a group which has 1 to 6 carbon atoms. It encompasses aromatic and heteroaromatic groups and also alkyl, cycloalkyl, alkoxy, cycloalkoxy, alkenyl, alkanoyl, alkoxycarbonyl groups and also heteroaliphatic groups. These groups may be branched or unbranched. Moreover, these groups may have substituents, especially halogen atoms or hydroxyl groups.

The radicals R′ stand preferably for alkyl groups. The preferred alkyl groups include the methyl, ethyl, propyl, isopropyl, 1-butyl, 2-butyl, 2-methylpropyl or tert-butyl group.

The group Z stands preferably for a linking group which comprises 1 to 10, preferably 1 to 5 and very preferably 2 to 3 carbon atoms. Such radicals include, in particular, linear or branched, aliphatic or cycloaliphatic radicals, such as, for example, a methylene, ethylene, propylene, isopropylene, n-butylene, isobutylene, tert-butylene or cyclohexylene group, the ethylene group being particularly preferred.

The group R² in formula (II) stands for an unsaturated radical having 9 to 25 carbon atoms. These groups encompass, in particular, alkenyl, cycloalkenyl, alkenoxy, cycloalkenoxy, alkenoyl and also heteroaliphatic groups. Furthermore, these groups may have substituents, especially halogen atoms or hydroxyl groups. The preferred groups include, in particular, alkenyl groups, such as, for example, the nonenyl, decenyl, undecenyl, dodecenyl, tridecenyl, tetradecenyl, pentadecenyl, hexadecenyl, heptadecenyl, octadecenyl, nonadecenyl, eicosenyl, heneicosenyl, docosenyl, octadienyl, nonadienyl, decadienyl, undecadienyl, dodecadienyl, tridecadienyl, tetradecadienyl, pentadecadienyl, hexadecadienyl, heptadecadienyl, octadecadienyl, nonadecadienyl, eicosadienyl, heneicosadienyl, docosadienyl, tricosadienyl and/or heptadecatrienyl group.

The preferred (meth)acrylic monomers of formula (II) and (III), respectively, include, among others, heptadecenyloyloxy-2-ethyl-(meth)acrylamide, heptadecadienyloyloxy-2-ethyl-(meth)acrylamide, heptadecatrienyloyloxy-2-ethyl-(meth)acrylamide, heptadecenyloyloxy-2-ethyl-(meth)acrylamide, (meth)acryloyloxy-2-ethyl-palmitoleamide, (meth)acryloyloxy-2-ethyl-oleamide, (meth)acryloyloxy-2-ethyl-icosenamide, (meth)acryloyloxy-2-ethyl-cetoleamide, (meth)acryloyloxy-2-ethyl-erucamide, (meth)acryloyloxy-2-ethyl-linoleamide, (meth)acryloyloxy-2-ethyl-linolenamide, (meth)acryloyloxy-2-propyl-palmitoleamide, (meth)acryloyloxy-2-propyl-oleamide, (meth)acryloyloxy-2-propyl-icosenamide, (meth)acryloyloxy-2-propyl-cetoleamide, (meth)acryloyloxy-2-propyl-erucamide, (meth)acryloyloxy-2-propyl-linoleamide and (meth)acryloyloxy-2-propyl-linolenamide.

The (meth)acryloyl notation stands for acryloyl and methacryloyl radicals, with methacryloyl radicals being preferred. Particularly preferred monomers of formula (II) and (III) are methacryloyloxy-2-ethyl-oleamide, methacryloyloxy-2-ethyl-linoleamide, and/or methacryloyloxy-2-ethyl-Iinolenamide.

The (meth)acrylic monomers of formula (II) and (III) can be obtained in particular by multi-stage processes. In a first stage, for example, one or more unsaturated fatty acids or fatty acid esters can be reacted with an amine, such as ethylenediamine, ethanolamine, propylenediamine or propanolamine, for example, to form an amide. In a second stage, the hydroxyl group or the amine group of the amide is reacted with a (meth)acrylate, methyl (meth)acrylate for example, to give the monomers of the formula (II) or (III). For preparing monomers in which X′ is a group of the formula NR′, in which R′ is hydrogen or a radical having 1 to 6 carbon atoms, and X² is oxygen, correspondingly, it is possible first to react an alkyl(meth)acrylate, methyl(meth)acrylate for example, with one of the aforementioned amines, to form a (meth)acrylamide having a hydroxyl group in the alkyl radical, which is subsequently reacted with an unsaturated fatty acid to form a (meth)acrylic monomer of formula (II) or (III). Transesterifications of alcohols with (meth)acrylates, or the preparation of (meth)acrylamides, are set out in publications including CN 1355161, DE 21 29 425 filed on 14.06.71 at the German Patent Office, having the application number P 2129425.7, DE 34 23 443 filed on 16.09.92 at the European Patent Office having the application number EP 92308426.3 or EP-A-0 534 666 filed on 26.06.84 at the German Patent Office having the application number P 3423443.8, the reaction conditions described in these publications and also the catalysts, etc., set out therein being incorporated for purposes of disclosure into this specification. Moreover, these reactions are described in “Synthesis of Acrylic Esters by Transesterification”, J. Haken, 1967.

Intermediates obtained in these reactions, such as carboxamides which have hydroxyl groups in the alkyl radical, for example, can be purified. In one particular embodiment of the present invention, resultant intermediates can be reacted without costly and inconvenient purification, to form the (meth)acrylic monomers of formula (II) or (III).

Furthermore, the (meth)acrylic monomers having 8 to 40, preferably 10 to 30 and more preferably 12 to 20 carbon atoms and at least one double bond in the alkyl radical include, in particular, monomers of the general formula (IV)

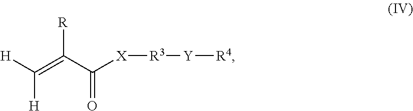

in which R is hydrogen or a methyl group, X is oxygen or a group of the formula NR′, in which R′ is hydrogen or a radical having 1 to 6 carbon atoms, R³ is an alkylene group having 1 to 22 carbon atoms, Y is oxygen, sulphur or a group of the formula NR″, in which R″ is hydrogen or a radical having 1 to 6 carbon atoms, and R⁴ is an unsaturated radical having at least 8 carbon atoms and at least two double bonds.

In formula (IV) the radical R³ is an alkylene group having 1 to 22 carbon atoms, preferably having 1 to 10, more preferably having 2 to 6, carbon atoms. In one particular embodiment of the present invention the radical R³ is an alkylene group having 2 to 4, more preferably 2, carbon atoms. The alkylene groups having 1 to 22 carbon atoms include, in particular, the methylene, ethylene, propylene, isopropylene, n-butylene, iso-butylene, tert-butylene or cyclohexylene group, the ethylene group being particularly preferred.

The radical R⁴ comprises at least two C-C double bonds which are not part of an aromatic system. The radical R⁴ is preferably a group having precisely 8 carbon atoms which has precisely two double bonds. The radical R⁴ is preferably a linear hydrocarbon radical which contains no heteroatoms. In one particular embodiment of the present invention the radical R⁴ in formula (IV) may comprise a terminal double bond. In another modification of the present invention the radical R⁴ in formula (IV) may comprise no terminal double bond. The double bonds present in the radical R⁴ may preferably be conjugated. In a further preferred embodiment of the present invention the double bonds present in the radical R⁴ are not conjugated. The preferred radicals R⁴ which have at least two double bonds include, among others, the octa-2,7-dienyl group, octa-3,7-dienyl group, octa-4,7-dienyl group, octa-5,7-dienyl group, octa-2,4-dienyl group, octa-2,5-dienyl group, octa-2,6-dienyl group, octa-3,5-dienyl group, octa-3,6-dienyl group and octa-4,6-dienyl group.

The (meth)acrylic monomers of the general formula (IV) include, among others, 2-[((2-E)octa-2,7-dienyl)methylamino]ethyl 2-methylprop-2-enoate, 2-[((2-Z)octa-2,7-dienyl)methylamino]ethyl 2-methylprop-2-enoate, 2-[((3-E)octa-3,7-dienyl)methylamino]ethyl 2-methylprop-2-enoate, 2-[((4-Z)octa-4,7-dienyl)methylamino]ethyl 2-methylprop-2-enoate, 2-[(octa-2,6-dienyl)methylamino]ethyl 2-methylprop-2-enoate, 2-[(octa-2,4-dienyl)methylamino]ethyl 2-methylprop-2-enoate, 2-[(octa-3,5-dienyl)methylamino]ethyl 2-methylprop-2-enoate, 2-[((2-E)octa-2,7-dienyl)methylamino]ethyl(meth)acrylamide, 2-[((2-Z)octa-2,7-dienyl)methylamino]ethyl(meth)acrylamide, 2-[((3-E)octa-3,7-dienyl)methylamino]ethyl-(meth)acrylamide, 2-[((4-Z)octa-4,7-dienyl)methylamino]ethyl(meth)acrylamide, 2-[(octa-2,6-dienyl)methylamino]ethyl(meth)acrylamide, 2-[(octa-2,4-dienyl)methylamino]ethyl-(meth)acrylamide, 2-[(octa-3,5-dienyl)methylamino]ethyl-(meth)acrylamide, 2-[((2-E)octa-2,7-d ienyl)ethylamino]ethyl 2-methylprop-2-enoate, 2-[((2-Z)octa-2,7-dienyl)ethylamino]ethyl 2-methylprop-2-enoate, 2-[((3-E)octa-3,7-dienyl)ethylamino]ethyl 2-methylprop-2-enoate, 2-[((4-Z)octa-4,7-dienyl)ethylamino]ethyl 2-methylprop-2-enoate, 2-[(octa-2,6-dienyl)ethylamino]ethyl 2-methylprop-2-enoate, 2-[(octa-2,4-dienyl)ethylamino]ethyl 2-methylprop-2-enoate, 2-[(octa-3,5-dienyl)ethylamino]ethyl 2-methylprop-2-enoate, 2-[((2-E)octa-2,7-dienyl)methylamino]ethyl prop-2-enoate, 2-[((2-Z)octa-2,7-dienyl)methylamino]ethyl prop-2-enoate, 2-[((3-E)octa-3,7-dienyl)methylamino]ethyl prop-2-enoate, 2-[((4-Z)octa-4,7-dienyl)methylamino]ethyl prop-2-enoate, 2-[(octa-2,6-dienyl)methylamino]ethyl prop-2-enoate, 2-[(octa-2,4-dienyl)methylamino]ethyl prop-2-enoate, 2-[(octa-3,5-dienyl)methylamino]ethyl prop-2-enoate, 2-((2-E)octa-2,7-dienyloxy)ethyl 2-methylprop-2-enoate, 2-((2-Z)octa-2,7-dienyloxy)ethyl 2-methylprop-2-enoate, 2-((3-E)octa-3,7-dienyloxy)ethyl 2-methylprop-2-enoate, 2-((4-Z)octa-4,7-dienyloxy)ethyl 2-methylprop-2-enoate, 2-(octa-2,6-dienyloxy)ethyl 2-methylprop-2-enoate, 2-(octa-2,4-dienyloxy)ethyl 2-methylprop-2-enoate, 2-(octa-3,5-dienyloxy)ethyl 2-methylprop-2-enoate, 2-((2-E)octa-2,7-dienyloxy)ethyl prop-2-enoate, 2-((2-Z)octa-2,7-dienyloxy)ethyl prop-2-enoate, 2-((3-E)octa-3,7-dienyloxy)ethyl prop-2-enoate, 2-((4-Z)octa-4,7-dienyloxy)ethyl prop-2-enoate, 2-(octa-2,6-dienyloxy)ethyl prop-2-enoate, 2-(octa-2,4-dienyloxy)ethyl prop-2-enoate and 2-(octa-3,5-dienyloxy)ethyl prop-2-enoate.

The above-stated (meth)acrylic monomers of formula (IV) can be obtained in particular by processes in which (meth)acrylic acid or a (meth)acrylate, more particularly methyl(meth)acrylate or ethyl(meth)acrylate is reacted with an alcohol and/or an amine. These reactions have been set out above.

The reactant for reaction with the (meth)acrylic acid or the (meth)acrylate may advantageously conform to the formula (V)

H—X—R³—Y—R⁴ (V),

in which X is oxygen or a group of the formula NR′, in which R′ is hydrogen or a radical having 1 to 6 carbon atoms, R³ is an alkylene group having 1 to 22 carbon atoms, Y is oxygen, sulphur or a group of the formula NR″, in which R″ is hydrogen or a radical having 1 to 6 carbon atoms, and R⁴ is an at least doubly unsaturated radical having at least 8 carbon atoms.

With regard to the definition of preferred radicals R′, R″, R³, Y and R⁴, reference is made to the description of the formula (IV).

The preferred reactants according to formula (V) include (methyl(octa-2,7-dienyl)amino)ethanol, (ethyl(octa-2,7-dienyl)amino)ethanol, 2-octa-2 ,7-d ienyloxyethanol, (methyl(octa-2,7-dienyl)amino)ethylamine, (methyl(octa-3,7-dienyl)amino)ethanol, (ethyl(octa-3,7-dienyl)amino)ethanol, 2-octa-3,7-dienyloxyethanol, (methyl(octa-3,7-dienyl)amino)ethylamine, (methyl(octa-4,7-d ienyl)amino)ethanol, (ethyl(octa-4,7-dienyl)amino)ethanol, 2-octa-4,7-dienyloxyethanol, (methyl(octa-4,7-dienyl)amino)ethylamine, (methyl(octa-5,7-dienyl)amino)ethanol, (ethyl(octa-5,7-dienyl)amino)ethanol, 2-octa-5,7-dienyloxyethanol, (methyl(octa-5,7-dienyl)amino)ethylamine, (methyl(octa-2,6-dienyl)amino)ethanol, (ethyl(octa-2,6-dienyl)amino)ethanol, 2-octa-2,6-dienyloxyethanol, (methyl(octa-2,6-dienyl)amino)ethylamine, (methyl(octa-2,5-dienyl)amino)ethanol, (ethyl(octa-2,5-dienyl)amino)ethanol, 2-octa-2,5-dienyloxyethanol, (methyl(octa-2,5-dienyl)amino)ethylamine, (methyl(octa-2,4-dienyl)amino)ethanol, (ethyl(octa-2,4-dienyl)amino)ethanol, 2-octa-2,4-dienyloxyethanol, (methyl(octa-2,4-dienyl)amino)ethylamine, (methyl(octa-3,6-dienyl)amino)ethanol, (ethyl(octa-3,6-dienyl)amino)ethanol, 2-octa-3,6-dienyloxyethanol, (methyl(octa-3,6-dienyl)amino)ethylamine, (methyl(octa-3,5-dienyl)amino)ethanol, (ethyl(octa-3,5-dienyl)amino)ethanol, 2-octa-3,5-dienyloxyethanol, (methyl(octa-3,5-dienyl)amino)ethylamine, (methyl(octa-4,6-dienyl)amino)ethanol, (ethyl(octa-4,6-dienyl)amino)ethanol, 2-octa-4,6-dienyloxyethanol and (methyl(octa-4,6-dienyl)amino)ethylamine. The reactants according to formula (V) may be used individually or as a mixture.

The reactants of formula (V) can be obtained by methods which include known methods of the telomerization of 1,3-butadiene. The term “telomerization” denotes the reaction of compounds having conjugated double bonds in the presence of nucleophiles. The methods set out in publications WO 2004/002931 filed on Jun. 17, 2003 at the European Patent Office having the application number PCT/EP2003/003656, WO 03/031379 filed on Jan. 10, 2002 having the application number PCT/EP2002/10971 and WO 02/100803 filed on Apr. 5, 2002 having the application number PCT/EP2002/04909, in particular the catalysts used for the reaction and the reaction conditions, such as pressure and temperature, for example, are incorporated for purposes of disclosure into the present specification.

The telomerization of 1,3-butadiene may take place preferably with use of metal compounds comprising metals from groups 8 to 10 of the Periodic Table of the Elements as catalyst, it being possible with particular preference to use palladium compounds, especially palladium carbene complexes, which are set out in more detail in the above-stated publications.

As nucleophiles it is possible to use, in particular, dialcohols, such as ethylene glycol, 1,2-propanediol, 1,3-propanediol; diamines, such as ethylenediamine, N-methylethylenediamine, N,N′-dimethylethylenediamine or hexamethylenediamine; or aminoalkanols, such as aminoethanol, N-methylaminoethanol, N-ethylaminoethanol, aminopropanol, N-methylaminopropanol or N-ethylaminopropanol.

When the nucleophile used is (meth)acrylic acid, octadienyl(meth)acrylates, for example, may be obtained, which are particularly suitable as (meth)acrylic monomers having 8 to 40 carbon atoms.

The temperature at which the telomerization reaction is performed is between 10 and 180° C., preferably between 30 and 120° C., more preferably between 40 and 100° C. The reaction pressure is 1 to 300 bar, preferably 1 to 120 bar, more preferably 1 to 64 bar and very preferably 1 to 20 bar.

Isomers of compounds which have an octa-2,7-dienyl group can be prepared by isomerization of the double bonds present in the compounds having an octa-2,7-dienyl group.

The above-stated (meth)acrylic monomers which in the alkyl radical have at least one double bond and 8 to 40 carbon atoms can be used individually or as a mixture of two or more monomers.

The (meth)acrylate polymer of the present invention further comprises 0.1% to 10%, preferably 0.5% to 8% and more preferably 1% to 5% by weight of units derived from monomers containing acid groups, based on the total weight of the (meth)acrylate polymer.

Monomers containing acid groups are compounds which can be copolymerized preferably free-radically with the above-stated (meth)acrylic monomers. They include, for example, monomers having a sulphonic acid group, such as vinylsulphonic acid; monomers having a phosphonic acid group, such as vinylphosphonic acid; and unsaturated carboxylic acids, such as methacrylic acid, acrylic acid, fumaric acid and maleic acid. Particularly preferred are methacrylic acid and acrylic acid. The monomers containing acid groups may be used individually or as a mixture of two, three or more monomers containing acid groups.

Besides the above-stated (meth)acrylic monomers which in the alkyl radical have at least one double bond and 8 to 40 carbon atoms, and the monomers containing acid groups, (meth)acrylate polymers of the invention comprise 50% to 99.4%, preferably 60% to 98% and very preferably 80% to 97% by weight of units derived from (meth)acrylates having 1 to 12 carbon atoms in the alkyl radical that have no double bonds or heteroatoms in the alkyl radical, and these (meth)acrylates having 1 to 12 carbon atoms in the alkyl radical are selected such that a polymer composed of these (meth)acrylates having 1 to 12 carbon atoms in the alkyl radical has a glass transition temperature of at least 40° C. based on the weight of the (meth)acrylate polymer.

The above-stated (meth)acrylates having 1 to 12 carbon atoms are selected such that a polymer composed of these (meth)acrylates having 1 to 12 carbon atoms in the alkyl radical has a glass transition temperature of at least 40° C., preferably at least 50° C. and more preferably at least 60° C. The glass transition temperature, Tg, of the polymer may be determined in a known way by means of Differential Scanning calorimetry (DSC), in particular in accordance with DIN EN ISO 11357. The glass transition temperature may be determined preferably as the mid-point of the glass stage of the second heating curve, with a heating rate of 10° C. per minute. Furthermore, the glass transition temperature Tg may also be calculated approximately in advance by means of the Fox equation. According to Fox T.G., Bull. Am. Physics Soc. 1, 3, page 123 (1956), it holds that:

$$\frac{1}{Tg} = \frac{{x}_{1}}{{Tg}_{1}} + \frac{{x}_{2}}{{Tg}_{2}} + … + \frac{{x}_{n}}{{Tg}_{n}}$$

where xₙ is the mass fraction (% by weight/100) of the monomer n and Tgₙ is the glass transition temperature in kelvins of the homopolymer of the monomer n. Further useful information can be found by the skilled person in the Polymer Handbook 2^{nd} Edition, J. Wiley & Sons, New York (1975), which reports Tg values for the most familiar homopolymers. According to that handbook, for example, poly(methyl methacrylate) has a glass transition temperature of 378 K, poly(butyl methacrylate) one of 297 K, poly(isobornyl methacrylate) one of 383 K, poly(isobornyl acrylate) one of 367 K and poly(cyclohexyl methacrylate) one of 356 K. To determine the glass transition temperature, the polymer composed of the (meth)acrylates mentioned having 1 to 12 carbon atoms in the alkyl radical may have a weight-average molecular weight of at least 100 000 g/mol and a number-average molecular weight of at least 80 000 g/mol.

The above-stated (meth)acrylates having 1 to 12 carbon atoms in the alkyl radical can be used individually or as a mixture, the mixtures resulting in copolymers which exhibit a correspondingly high glass transition temperature. Nature and amount may be selected via the above-stated formula of Fox et al.

The (meth)acrylates having 1 to 12 carbon atoms in the alkyl radical that have no double bonds or heteroatoms in the alkyl radical include, among others, (meth)acrylates having a linear or branched alkyl radical, such as, for example, methyl(meth)acrylate, ethyl(meth)acrylate, n-propyl(meth)acrylate, isopropyl(meth)acrylate, n-butyl(meth)acrylate, isobutyl(meth)acrylate, tert-butyl(meth)acrylate and pentyl(meth)acrylate, hexyl(meth)acrylate, 2-ethylhexyl(meth)acrylate, heptyl(meth)acrylate, octyl(meth)acrylate, 3-isopropylheptyl(meth)acrylate, nonyl(meth)acrylate, decyl(meth)acrylate, undecyl(meth)acrylate, 5-methylundecyl(meth)acrylate, dodecyl(meth)acrylate; and cycloalkyl(meth)acrylates, such as cyclopentyl(meth)acrylate, cyclohexyl(meth)acrylate, cyclohexyl(meth)acrylates having at least one substituent on the ring, such as tert-butylcyclohexyl(meth)acrylate and trimethylcyclohexyl(meth)acrylate, norbornyl(meth)acrylate, methylnorbornyl(meth)acrylate and dimethylnorbornyl(meth)acrylate, bornyl(meth)acrylate, 1-adamantyl(meth)acrylate, 2-adamantyl(meth)acrylate, menthyl(meth)acrylate and isobornyl(meth)acrylate.

Surprising advantages are manifested in particular by (meth)acrylate polymers having 50% to 99.4% by weight of units derived from methyl methacrylate and/or butyl methacrylate, preferably n-butyl methacrylate, based on the weight of the (meth)acrylate polymer. Especially preferred in this context are polymers which comprise 25% to 50% by weight of units derived from methyl methacrylate and 20% to 60% by weight of units derived from butyl methacrylate, based in each case on the weight of the (meth)acrylate polymer.

Further of particular interest are (meth)acrylate polymers which comprise preferably 0.1% to 99.4%, 5 to 50% and very preferably 20% to 40% by weight of units derived from cycloalkyl (meth)acrylates, more particularly from cyclohexyl methacrylate, cyclohexyl acrylate, cyclohexyl (meth)acrylates having at least one substituent on the ring, such as tert-butylcyclohexyl methacrylate and trimethylcyclohexyl(meth)acrylate, preferably 2,4,6-trimethylcyclohexyl methacrylate, isobornyl acrylate and/or isobornyl methacrylate.

In addition to the obligatory repeating units set out above, the (meth)acrylate polymer may comprise units derived from comonomers. These comonomers differ from the above-stated units of the polymer, but can be copolymerized with the above-stated monomers. The (meth)acrylate polymer preferably comprises not more than 20% by weight, more preferably not more than 10% by weight, of units derived from comonomers.

These include, for example, (meth)acrylates having at least 13 carbon atoms in the alkyl radical and deriving from saturated alcohols, such as, for example, 2-methyldodecyl(meth)acrylate, tridecyl(meth)acrylate, 5-methyltridecyl(meth)acrylate, tetradecyl(meth)acrylate, pentadecyl(meth)acrylate, hexadecyl(meth)acrylate, 2-methylhexadecyl(meth)acrylate, heptadecyl(meth)acrylate, 5-isopropylheptadecyl(meth)acrylate, 4-tert-butyloctadecyl(meth)acrylate, 5-ethyloctadecyl(meth)acrylate, 3-isopropyloctadecyl(meth)acrylate, octadecyl(meth)acrylate, nonadecyl(meth)acrylate, eicosyl(meth)acrylate, cetyleicosyl(meth)acrylate, stearyleicosyl(meth)acrylate, docosyl(meth)acrylate and/or eicosyltetratriacontyl(meth)acrylate;

cycloalkyl(meth)acrylates, such as 2,4,5-tri-tert-butyl-3-vinylcyclohexyl(meth)acrylate, 2,3,4,5-tetra-tert-butylcyclohexyl(meth)acrylate;

heterocyclic(meth)acrylates, such as 2-(1-imidazolyl)ethyl(meth)acrylate, 2-(4-morpholinyl)ethyl(meth)acrylate, 1-(2-methacryloyloxyethyl)-2-pyrrolidone;

nitriles of (meth)acrylic acid and other nitrogen-containing methacrylates, such as N-(methacryloyloxyethyl)diisobutylketimine, N-(methacryloyloxyethyl)dihexadecylketimine, methacryloylamidoacetonitrile, 2-methacryloyloxyethylmethylcyanamide, cyanomethyl methacrylate;

aryl(meth)acrylates, such as benzyl(meth)acrylate or phenyl(meth)acrylate, it being possible for each of the aryl radicals to be unsubstituted or substituted up to four times;

(meth)acrylates having a hydroxyl group in the alkyl radical, more particularly 2-hydroxyethyl(meth)acrylate, preferably 2-hydroxyethyl methacrylate (HEMA), hydroxypropyl(meth)acrylate, such as 2-hydroxypropyl(meth)acrylate and 3-hydroxypropyl(meth)acrylate, preferably hydroxypropyl methacrylate (HPMA), hydroxybutyl(meth)acrylate, preferably hydroxybutyl methacrylate (HBMA), 3,4-dihydroxybutyl(meth)acrylate, 2,5-dimethyl-1,6-hexandiol(meth)acrylate, 1,10-decandiol(meth)acrylate, glycerol mono(meth)acrylate, and polyalkoxylated derivatives of (meth)acrylic acid, especially polypropylene glycol mono(meth)acrylate having 2 to 10, preferably 3 to 6, propylene oxide units, preferably polypropylene glycol monomethacrylate having about 5 propylene oxide units (PPM5), polyethylene glycol mono(meth)acrylate having 2 to 10, preferably 3 to 6, ethylene oxide units, preferably polyethylene glycol monomethacrylate having about 5 ethylene oxide units (PEM5), polybutylene glycol mono(meth)acrylate, polyethylene glycol polypropylene glycol mono(meth)acrylate;

(meth)acrylamides, especially N-methylol(meth)acrylamide, N,N-dimethylaminopropyl(meth)acrylamide, tert-butylaminoethyl methacrylate, methacrylamide and acrylamide; and

(meth)acrylates which derive from saturated fatty acid amides, such as pentadecyloyloxy-2-ethyl-(meth)acrylamide, heptadecyloyloxy-2-ethyl-(meth)acrylamide, (meth)acryloyloxy-2-ethyl-lauramide, (meth)acryloyloxy-2-ethyl-myristamide, (meth)acryloyloxy-2-ethyl-palmitamide, (meth)acryloyloxy-2-ethyl-stearamide, (meth)acryloyloxy-2-propyl-lauramide, (meth)acryloyloxy-2-propyl-myristamide, (meth)acryloyloxy-2-propyl-palmitamide and (meth)acryloyloxy-2-propyl-stearamide.

The comonomers further include vinyl esters, such as vinyl acetate, vinyl chloride, vinyl versatate, ethylene-vinyl acetate, ethylene-vinyl chloride;

maleic acid derivatives, such as maleic anhydride, esters of maleic acid, such as dimethyl maleate, methylmaleic anhydride; and fumaric acid derivatives, such as dimethyl fumarate.

A further group of comonomers are styrene monomers, such as, for example, styrene, substituted styrenes having an alkyl substituent in the side chain, such as α-methylstyrene and α-ethylstyrene, substituted styrenes having an alkyl substituent on the ring, such as vinyltoluene and p-methylstyrene, and halogenated styrenes, such as monochlorostyrenes, dichlorostyrenes, tribromostyrenes and tetrabromostyrenes, for example.

Heterocyclic vinyl compounds, such as 2-vinylpyridine, 3-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl-1-vinylimidazole, N-vinylpyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles and hydrogenated vinylthiazoles, vinyloxazoles and hydrogenated vinyloxazoles;

maleimide, methylmaleimide;

vinyl and isoprenyl ethers; and

vinyl halides, such as, for example, vinyl chloride, vinyl fluoride, vinylidene chloride and vinylidene fluoride, represent further examples of comonomers.

The weathering resistance of the coatings may be improved in particular through a reduction in the fraction of styrene monomers in the (meth)acrylate polymer and in the coating material, and so particularly UV-resistant coatings can be obtained by means of a styrene-free coating material. In one particular modification of the present invention, the (meth)acrylate polymer contains preferably not more than 20%, more preferably not more than 10%, by weight of units derived from styrene monomers, more particularly from styrene, substituted styrenes having an alkyl substituent in the side chain, substituted styrenes having an alkyl substituent on the ring and/or halogenated styrenes, based on the total weight of the (meth)acrylate polymer.

Preference is given, furthermore, to (meth)acrylate polymers which contain not more than 20%, more preferably not more than 10%, by weight of units derived from other functionalized (meth)acrylates. Functionalized (meth)acrylates include (meth)acrylates having hydroxyl groups in the alkyl radical, and aromatic and heterocyclic(meth)acrylates.

A further class of comonomers is presented by crosslinking monomers. These monomers have at least two double bonds possessing similar reactivity in the context of a free-radical polymerization. These monomers include more particularly (meth)acrylates deriving from unsaturated alcohols, such as allyl(meth)acrylate and vinyl(meth)acrylate, for example, and (meth)acrylates deriving from diols or higher polyfunctional alcohols, such as, for example, glycol di(meth)acrylates, such as ethylene glycol di(meth)acrylate, diethylene glycol di(meth)acrylate, triethylene glycol di(meth)acrylate, tetra- and polyethylene glycol di(meth)acrylate, 1,3-butanediol di(meth)acrylate, 1,4-butanediol di(meth)acrylate, 1,6-hexanediol di(meth)acrylate, glycerol di(meth)acrylate and diurethane dimethacrylate; (meth)acrylates having three or more double bonds, such as glycerol tri(meth)acrylate, trimethylolpropane tri(meth)acrylate, pentaerythritol tetra(meth)acrylate and dipentaerythritol penta(meth)acrylate.

In one particular modification of the present invention, the fraction of crosslinking monomers may be in the range from 0.1% to 5% by weight, more preferably in the range from 2% to 3% by weight.

The (meth)acrylate polymer of the invention has a weight-average molecular weight in the range from 10 000 g/mol to 60 000 g/mol, more preferably in the range from 15 000 to 40 000 g/mol. The number-average molecular weight of preferred (meth)acrylate polymers is in the range from 1000 to 60 000 g/mol, more preferably in the range from 3000 to 25 000 g/mol. Also of particular interest are (meth)acrylate polymers which have a polydispersity index, M_{w}/Mₙ, in the range from 1 to 10, more preferably in the range from 1.5 to 7 and very preferably 1.7 to 3. The molecular weight can be determined by means of gel permeation chromatography (GPC) against a PMMA standard.

In one particular aspect of the present invention the (meth)acrylate polymer may have a molecular weight distribution having at least 2 maxima, as measured by gel permeation chromatography.

The glass transition temperature of the (meth)acrylate polymer is preferably in the range from 10° C. to 80° C., more preferably in the range from 25 to 75° C. and very preferably in the range from 40 to 70° C. The glass transition temperature may be influenced via the nature and proportion of the monomers used for preparing the (meth)acrylate polymer. The glass transition temperature Tg of the polymer may be determined in a known way by means of Differential Scanning calorimetry (DSC), more particularly in accordance with DIN EN ISO 11357. The glass transition temperature may be determined with preference as the mid-point of the glass stage of the second heating curve, with a heating rate of 10° C. per minute. Furthermore, the glass transition temperature Tg may also be calculated approximately in advance by means of the above-described Fox equation.

The iodine number of the (meth)acrylate polymers of the invention is preferably in the range from 1 to 60 g iodine per 100 g polymer, more preferably in the range from 2 to 50 g iodine per 100 g polymer and very preferably 5 to 40 g iodine per 100 g polymer, measured in accordance with DIN 53241-1.

The hydroxyl number of the polymer may be situated preferably in the range from 0 to 180 mg KOH/g, more preferably 0.1 to 100 mg KOH/g and very preferably in the range from 0.2 to 20 mg KOH/g. The hydroxyl number may be determined in accordance with DIN EN ISO 4629.

The (meth)acrylate polymers for use in accordance with the invention may be obtained in particular by solution polymerizations, bulk polymerizations, suspension polymerizations or emulsion polymerizations, it being possible to achieve surprising advantages by means of a radical solution polymerization. These methods are set out in Ullmann's Encyclopedia of Industrial Chemistry, Sixth Edition.

As well as methods of conventional radical polymerization it is also possible to employ related methods of controlled radical polymerization, such as, for example, ATRP (=Atom Transfer Radical Polymerization), NMP (Nitroxide-mediated Polymerization) or RAFT (=Reversible Addition Fragmentation Chain Transfer).

References describing typical free radical polymerization include Ullmanns's Encyclopedia of Industrial Chemistry, Sixth Edition. For such polymerization, generally speaking, a polymerization initiator and also, optionally, a molecular-weight-regulating chain-transfer agent are employed.

The initiators which can be used include, among others, the azo initiators that are widely known in the art, such as AIBN and 1,1-azobiscyclohexanecarbonitrile, and also peroxy compounds, such as methyl ethyl ketone peroxide, acetylacetone peroxide, dilauryl peroxide, tert-butyl per-2-ethylhexanoate, ketone peroxide, tert-butyl peroctoate, methyl isobutyl ketone peroxide, cyclohexanone peroxide, dibenzoyl peroxide, tert-butyl peroxybenzoate, tert-butylperoxyisopropyl carbonate, 2,5-bis(2-ethylhexanoylperoxy)-2,5-dimethylhexane, tert-butylperoxy-2-ethylhexanoate, tert-butylperoxy-3,5,5-trimethylhexanoate, dicumyl peroxide, 1,1-bis(tert-butylperoxy)cyclohexane, 1,1-bis(tert-butylperoxy)-3,3,5-trimethylcyclohexane, cumyl hydroperoxide, tert-butyl hydroperoxide, bis(4-tert-butylcyclohexyl)peroxydicarbonate, mixtures of two or more of the aforementioned compounds with one another, and mixtures of the aforementioned compounds with nonspecified compounds that may likewise form free radicals.

The stated initiators may be used either individually or in a mixture. They are used preferably in an amount of 0.05% to 10.0% by weight, more preferably 1% to 5% by weight, based on the total weight of the monomers. It is also possible with preference to carry out the polymerization using a mixture of different polymerization initiators having different half-lives.

The sulphur-free chain-transfer agents include, for example—without any intention hereby to impose any restriction—dimeric α-methylstyrene (2,4-diphenyl-4-methyl-1-pentene), enol ethers of aliphatic and/or cycloaliphatic aldehydes, terpenes, β-terpinene, terpinolene, 1,4-cyclohexadiene, 1,4-dihydronaphthalene, 1,4,5,8-tetrahydronaphthalene, 2,5-dihydrofuran, 2,5-dimethylfuran and/or 3,6-dihydro-2H-pyran; dimeric α-methylstyrene is preferred.

As sulphur-containing chain-transfer agents it is possible with preference to use mercapto compounds, dialkyl sulphides, dialkyl disulphides and/or diaryl sulphides. The following chain-transfer agents are specified by way of example: di-n-butyl sulphide, di-n-octyl sulphide, diphenyl sulphide, thiodiglycol, ethylthioethanol, diisopropyl disulphide, di-n-butyl disulphide, di-n-hexyl disulphide, diacetyl disulphide, diethanol sulphide, di-tert-butyl trisulphide and dimethyl sulphoxide. Preferred compounds used as chain-transfer agents are mercapto compounds, dialkyl sulphides, dialkyl disulphides and/or diaryl sulphides. Examples of these compounds are ethyl thioglycolate, 2-ethylhexyl thioglycolate, cysteine, 2-mercaptoethanol, 3-mercaptopropanol, 3-mercaptopropane-1,2-diol, 1,4-mercaptobutanol, mercaptoacetic acid, 3-mercaptopropionic acid, thioglycolic acid, mercaptosuccinic acid, thioglycerol, thioacetic acid, thiourea and alkyl mercaptans such as n-butyl mercaptan, n-hexyl mercaptan, t-dodecyl mercaptan or n-dodecyl mercaptan. Chain-transfer agents used with particular preference are mercaptoalcohols and mercaptocarboxylic acids.

The chain-transfer agents are used preferably in amounts of 0.05% to 10%, more preferably 1% to 4% by weight, based on the monomers used in the polymerization. In the polymerization it is of course also possible to employ mixtures of chain-transfer agents.

The polymerization can be carried out under atmospheric, subatmospheric or superatmospheric pressure. The polymerization temperature as well is not critical. Generally speaking, however, it is in the range of −20°-200° C., preferably 50°-150° C. and more preferably 80°-130° C.

The polymerization can be carried out with or without solvent. The term “solvent” should be understood widely in this context. The preferred solvents include, in particular, aromatic hydrocarbons, such as toluene, xylene; esters, especially acetates, preferably butyl acetate, ethyl acetate, propyl acetate; ketones, preferably ethyl methyl ketone, acetone, methyl isobutyl ketone or cyclohexanone; alcohols, especially isopropanol, n-butanol, isobutanol; ethers, especially glycol monomethyl ethers, glycol monoethyl ethers, glycol monobutyl ethers; aliphatics, preferably pentane, hexane, cycloalkanes and substituted cycloalkanes, such as cyclohexane; mixtures of aliphatics and/or aromatics, preferably naphtha; benzine, biodiesel; but also plasticizers such as low molecular weight polypropylene glycols or phthalates. The stated solvents may be used individually or as a mixture.

The polymers of the invention serve in particular for the preparation of coating materials, which are likewise subject matter of the present invention. These coating materials feature an outstanding spectrum of properties, including in particular outstanding processing properties in conjunction with excellent quality of the coating obtained. For instance, the coating materials of the invention can be processed within a wide temperature window, which preferably spans a width of at least 20° C., more preferably at least 30° C., without detriment to the quality of the coating, which is distinguished in particular by high solvent resistance and water resistance. Accordingly, a preferred coating material can be processed at a temperature of 15° C., 20° C., 30° C. or 40° C., without any substantial measurable deterioration in quality. Moreover, the coating materials of the invention are highly insensitive to humidity fluctuations in the course of processing, and hence the production of coatings with the coating materials is very independent of changes in weather.

The dynamic viscosity of the coating material is dependent on the solids content and on the nature of the solvent, and may encompass a wide range. Thus, with a high polymer content, it may be more than 20 000 mPas. An advantageous dynamic viscosity is usually one in the range from 10 to 10 000 mPas, preferably 100 to 8000 mPas and very preferably 1000 to 6000 mPas, measured in accordance with DIN EN ISO 2555 at 23° C. (Brookfield).

Of special interest in particular are coating materials which comprise preferably 10% to 80% by weight, more preferably 25% to 65% by weight, of at least one polymer of the invention.

Surprisingly good processing properties are displayed, moreover, by coating materials whose solids content is preferably at least 40% by weight, more preferably at least 60% by weight.

For a given solids content, the coating materials of the invention may be processed over a substantially broader temperature range than coating materials known to date. With comparable processing properties, the coating materials of the invention feature a surprisingly high solids content, and so the coating materials of the invention are particularly eco-friendly.

As well as the polymers of the invention, the above-stated coating materials may comprise at least one solvent. Examples of preferred solvents have been set out above in connection with a radical polymerization, and so reference is made thereto. The proportion of solvent in preferred coating materials may be situated in particular in the range from 0.1% to 60%, more preferably in the range from 5% to 40% by weight, based on the total weight of the coating material.

The coating materials of the invention may further comprise customary auxiliaries and adjuvants such as rheology modifiers, defoamers, deaerating agents, pigment wetting agents, dispersing additives, substrate wetting agents, lubricant and flow-control additives, in each case in an amount from 0% by weight to 3% by weight, based on the overall formula, and also water repellents, plasticizers, diluents, UV stabilizers and adhesion promoters, each in an amount from 0% by weight to 20% by weight, based on the overall formula.

Furthermore, the coating materials of the invention may contain customary fillers and pigments, such as talc, calcium carbonate, titanium dioxide, carbon black, etc., in an amount up to 50% by weight of the overall composition.

Furthermore, the present invention provides a method of producing a coating, in which a coating material of the invention is applied to a substrate and cured.

The coating composition of the invention can be applied by customary application techniques, such as dipping, rolling, flowcoating and pouring methods, more particularly by spreading, roller-coating and spraying methods (high-pressure, low-pressure, airless or electrostatic (ESTA)).

The coating material is cured by physical drying and by oxidative crosslinking by means of atmospheric oxygen. The oxidative curing may be accelerated by catalysts. In this case, typically, it is possible to use siccatives such as compounds of cobalt, of manganese, of lead, of zirconium, of iron, of cerium and of vanadium, or alkali metal compounds or alkaline earth metal compounds, which may comprise for example, lithium, potassium and calcium, in amounts, based on the solid, oxidatively curing binder, of greater than 0% to 7% by weight, preferably greater than 0 to 3% by weight and very preferably greater than 0 to 0.5% by weight. If necessary it is also possible to employ anti-skinning agents such as substituted phenols, an example being di-tert-butyl-p-cresol, or ketoximes. If necessary, moreover, through-volume driers such as sodium perborate, for example, can be added.

The substrates preferably providable with a coating material of the invention include, in particular, metals, especially iron and steel, zinc and galvanized steels, and also plastics and concrete substrates.

Furthermore, the present invention provides coated articles obtainable by a method of the invention. The coating of these articles is distinguished by an outstanding spectrum of properties.

Of further interest, in particular, is the high water resistance of coatings obtained by means of the coating materials of the invention.

Preferred coatings obtained from the coating materials of the invention exhibit a high Konig pendulum damping. The pendulum hardness after seven days is preferably at least 30 s, more preferably at least 50 s, measured in accordance with DIN ISO 1522.

The coatings obtainable from the coating materials of the invention exhibit a high solvent resistance. Preferred coatings are outstandingly resistant to polar solvents in particular, especially alcohols, such as 2-propanol, or ketones, such as methyl ethyl ketone (MEK), and to non-polar solvents, such as diesel fuel (alkanes), for example. Following exposure for 15 minutes with subsequent drying (24 hours at room temperature), preferred coatings in accordance with the present invention have a pendulum damping in accordance with DIN ISO 1522 of preferably at least 20 s, more preferably at least 40 s.

Furthermore, preferred coatings display surprisingly good cupping. In particular modifications of the present invention, preferred coatings can exhibit a cupping of at least 1 mm, more preferably at least 3.0 mm, as measured in accordance with DIN 53156 (Erichsen).

Preferred coatings exhibit improved flow. When the surface structure is subjected to measurement by means of laser beams (i.e. wavescan method), preferred binders and coating systems of the present invention display a shortwave of preferably not more than 40 units, more preferably not more than 30 units and very preferably not more than 10 units.

Furthermore, preferred coatings obtainable from the coating materials of the invention have a surprisingly strong adhesion, as can be determined, in particular, by the cross-cut test. Hence it is possible in particular to achieve a classification of 0 to 1, more preferably of 0, in accordance with the standard DIN EN ISO 2409.

The present invention is illustrated below with reference to inventive and one comparative example, without any intention that this should constitute a restriction.

Measurement Methods

Determination of Solids Content

The solids content was determined by weighing out about 0.5 g of binder solution, using an analytical balance, into an aluminium dish. 5 ml of acetone were added and were mixed with the binder solution by swirling. The acetone was evaporated off under a fume hood. Then the aluminium dish was placed in a drying cabinet at 105° C. for two hours. After cooling, the aluminium dish was weighed again, then placed in the drying cabinet for a further hour, and again weighed after cooling. When the weight is constant, the solids content of the binder solution is determined by the following formula: Solids of binder solution in percent by weight=Final mass of solid in g×100/Initial mass of binder solution

Determination of Gloss Values

The gloss values were measured according to DIN 67630. The measurement angle was 60°.

Measurement of Dynamic Viscosity

The dynamic viscosity was measured in accordance with DIN EN ISO 2555 using a Brookfield viscometer at 23° C.

Determination of Viscosity Number

The viscosity number was determined in accordance with DIN EN ISO 1628-1.

Determination of Molecular Weight

The molecular weight was determined via GPC in a method based on DIN EN ISO 55672-1. GPC columns from the manufacturer Varian/Polymer Laboratories were used, arranged in series with the pore sizes 10⁵, 10⁶, 10⁴ and 10³ Å. The individual columns were 300 mm long and had a diameter of 7.5 mm. A polymer solution was prepared with an initial concentration of 2.5 g of polymer per litre of solvent. THF was used as eluent, and a flow rate of 1 ml/min was operated. The injection volume was 100 μl. The column oven is conditioned to 35° C. Detection took place using the RI 150 detector from Thermo Electron. The data were evaluated using the WinGPC program from Polymerstandard-Service (PSS).

Mw denotes the weight-average molecular weight, D the polydispersity index (D=Mw/Mn, Mn=number-average molecular weight).

Determination of Glass Transition Temperature

The glass transition temperatures were measured using the DSC 1 instrument from Mettler Toledo in accordance with DIN EN ISO 11357. The glass transition temperature was defined as the midpoint of the glass stage of the second heating curve at 10° C. per minute.

König Pendulum Damping

The Konig pendulum damping was measured in accordance with DIN EN ISO 1522. The inventive coating systems and also the comparative systems were applied to glass plates using a 200 μm doctor blade, and dried at room temperature (23° C.).

Hiding Power

The hiding power was determined in accordance with DIN EN ISO 6504-3. The Y value was determined on contrast charts.

Pigmentation of the Binders and Coating Materials

For pigmentation, the respective binder solution was diluted to a solids content of 60% by weight (xylene). Then a mixture comprising 66.7% by weight of the binder solution obtained by dilution, 20% by weight of TiO₂ (Kronos® 2160), 0.23% by weight of red pigment (Bayferrox® 110) and 13.3% by weight of xylene was prepared and was added to 230 g of steatite balls in a 250 ml glass bottle. The glass bottle was sealed and stored on a roller bed for 24 hours. After that time, the steatite balls were separated from the pigmented paint by filtration.

Surface Structure by Wavescan

For the determination of the surface structure, the binder solution was diluted to a solids content of 60% and knife-coated in a film thickness of 75 μm onto a metal coil coating panel. The film was dried at room temperature.

Using the Wave-Scan instrument from BYK-Gardner, the waviness is analyzed in a wavelength length from 0.1 to 30 mm. The average values of three measurements of the longwave (LW) and of the shortwave (SW) are reported. The smaller the LW and SW values, the less pronounced the wave structure and the smoother the overall appearance.

Preparation of a Mixture of Methacryloyloxy-2-Ethyl-Fatty Acid Amides

A four-necked round-bottomed flask equipped with a sabre stirrer with stirring sleeve and stirring motor, nitrogen inlet, liquid-phase thermometer and a distillation bridge, was charged with 206.3 g (0.70 mol) of fatty acid methyl ester mixture, 42.8 g (0.70 mol) of ethanolamine and 0.27 g (0.26%) of LiOH. The fatty acid methyl ester mixture comprised 6% by weight of saturated C12 to C16 fatty acid methyl esters, 2.5% by weight of saturated C17 to C20 fatty acid methyl esters, 52% by weight of monounsaturated C18 fatty acid methyl esters, 1.5% by weight of monounsaturated C20 to C24 fatty acid methyl esters, 36% by weight of polyunsaturated C18 fatty acid methyl esters and 2% by weight of polyunsaturated C20 to C24 fatty acid methyl esters.

The reaction mixture was heated to 150° C. Over the course of 2 hours, 19.5 ml of methanol were removed by distillation. The resulting reaction product contained 86.5% of fatty acid ethanolamides. The reaction mixture obtained was processed further without purification.

After cooling had taken place, 1919 g (19.2 mol) of methyl methacrylate, 3.1 g of LiOH and an inhibitor mixture consisting of 500 ppm of hydroquinone monomethyl ether and 500 ppm of phenothiazine were added.

With stirring, the reaction apparatus was flushed with nitrogen for 10 minutes. Thereafter the reaction mixture was heated to boiling. The methyl methacrylate/methanol azeotrope was separated off and then the overhead temperature was raised in steps to 100° C. When the reaction was at an end, the reaction mixture was cooled to about 70° C. and filtered.

Excess methyl methacrylate was separated off on a rotary evaporator. This gave 370 g of product.

### INVENTIVE EXAMPLE 1

259 g of xylene were charged to a 2 l jacketed reactor with blade stirrer, reflux condenser and nitrogen inertization, and heated to 90° C. 216 g of a monomer mixture of 450 g of n-butyl methacrylate, 297 g of methyl methacrylate, 9 g of methacrylic acid, 84 g of methacryloyloxy-2-hydroxypropyllinoleic ester and 25 g of n-dodecyl mercaptan were introduced into the reactor. Then 24 g of a 20% strength solution of dilauryl peroxide in xylene were added. After about 15 minutes, the remainder of the monomer mixture and 73 g of a 20% strength solution of dilauryl peroxide in xylene were metered in over the course of 120 minutes at 110° C. After a further hour of stirring at 110° C., 29 g of a 20% strength solution of dilauryl peroxide in xylene were added and the mixture was stirred for one hour. The binder solution was cooled.

The weight-average molecular weight as determined by GPC was 17 600 g/mol; the polydispersity index was 1.9.

The solids content of the binder solution was 70.2% by weight and the Brookfield viscosity was 16 800 mPas.

### INVENTIVE EXAMPLE 2

242 g of xylene were charged to a 2 l jacketed reactor with blade stirrer, reflux condenser and nitrogen inertization, and heated to 90° C. 218 g of a monomer mixture of 366 g of n-butyl methacrylate, 297 g of methyl methacrylate, 9 g of methacrylic acid, 168 g of methacryloyloxy-2-hydroxypropyl-linoleic ester and 34 g of n-dodecyl mercaptan were introduced into the reactor. Then 24 g of a 20% strength solution of dilauryl peroxide in xylene were added. After about 15 minutes, the remainder of the monomer mixture and 108 g of a 20% strength solution of dilauryl peroxide in xylene were metered in over the course of 120 minutes at 110° C. After a further hour of stirring at 110° C., 15 g of a 20% strength solution of dilauryl peroxide in xylene were added and the mixture was stirred for one hour. The binder solution was cooled.

The weight-average molecular weight as determined by GPC was 15 300 g/mol; the polydispersity index was 1.9.

The solids content of the binder solution was 68.9% by weight and the Brookfield viscosity was 3600 mPas.

### INVENTIVE EXAMPLE 3

295 g of xylene were charged to a 2 l jacketed reactor with blade stirrer, reflux condenser and nitrogen inertization, and heated to 90° C. 199 g of a monomer mixture of 460 g of n-butyl methacrylate, 273 g of methyl methacrylate, 8 g of methacrylic acid, 39 g of methacryloyloxy-2-ethyl-fatty acid amide mixture and 16 g of n-dodecyl mercaptan were introduced into the reactor. Then 30 g of a 20% strength solution of dilauryl peroxide in xylene were added. After about 15 minutes, the remainder of the monomer mixture and 90 g of a 20% strength solution of dilauryl peroxide in xylene were metered in over the course of 120 minutes at 110° C. After a further hour of stirring at 110° C., 36 g of a 20% strength solution of dilauryl peroxide in xylene were added and the mixture was stirred for one hour. The binder solution was cooled.

### INVENTIVE EXAMPLE 4

313 g of xylene were charged to a 2 l jacketed reactor with blade stirrer, reflux condenser and nitrogen inertization, and heated to 90° C. 199 g of a monomer mixture of 457 g of n-butyl methacrylate, 275 g of methyl methacrylate, 9 g of methacrylic acid, 39 g of methacryloyloxy-2-hydroxypropyl-linoleic ester and 16 g of n-dodecyl mercaptan were introduced into the reactor. Then 30 g of a 20% strength solution of dilauryl peroxide in xylene were added. After about 15 minutes, the remainder of the monomer mixture and 91 g of a 20% strength solution of dilauryl peroxide in xylene were metered in over the course of 120 minutes at 110° C. After a further hour of stirring at 110° C., 9 g of a 40% strength solution of tert-butyl peroxyethylhexanoate in xylene were added and the mixture was stirred for one hour. The last step was repeated once again. The binder solution was cooled.

The weight-average molecular weight as determined by GPC was 23 500 g/mol; the polydispersity index was 2.0.

The coating material obtained was pigmented in accordance with the specification set out above. A coating obtained from the pigmented coating material had a hiding power of 99.67% and a gloss at 60° of 85 gloss units.

### COMPARATIVE EXAMPLE 1

295 g of xylene were charged to a 2 l jacketed reactor with blade stirrer, reflux condenser and nitrogen inertization, and heated to 90° C. 199 g of a monomer mixture of 499 g of n-butyl methacrylate, 273 g of methyl methacrylate, 8 g of methacrylic acid and 16 g of n-dodecyl mercaptan were introduced into the reactor. Then 30 g of a 20% strength solution of dilauryl peroxide in xylene were added. After about 15 minutes, the remainder of the monomer mixture and 90 g of a 20% strength solution of dilauryl peroxide in xylene were metered in over the course of 120 minutes at 110° C. After a further hour of stirring at 110° C., 36 g of a 20% strength solution of dilauryl peroxide in xylene were added and the mixture was stirred for one hour. The binder solution was cooled.

The weight-average molecular weight as determined by GPC was 19 300 g/mol; the polydispersity index was 1.7.

The coating material was applied to a glass plate, using a 200 pm doctor knife, and dried at room temperature (23° C.). The König pendulum damping was 38 s after one day, 69 s after seven days and 85 s after one month.

In addition, the levelling properties were determined by means of the Wavescan method set out above, the waviness measured having values of 1.6 (longwave) and 19.3 (shortwave).

The coating material obtained was pigmented in accordance with the specification set out above. A coating obtained from the pigmented coating material had a hiding power of 99.55% and a gloss at 60° of 75 gloss units.

### INVENTIVE EXAMPLE 5

295 g of xylene were charged to a 2 l jacketed reactor with blade stirrer, reflux condenser and nitrogen inertization, and heated to 90° C. 201 g of a monomer mixture of 301 g of n-butyl methacrylate, 197 g of methyl methacrylate, 9 g of methacrylic acid, 234 g of isobornyl methacrylate, 39 g of methacryloyloxy-2-hydroxypropyl-linoleic ester and 16 g of n-dodecyl mercaptan were introduced into the reactor. Then 30 g of a 20% strength solution of dilauryl peroxide in xylene were added. After about 15 minutes, the remainder of the monomer mixture and 90 g of a 20% strength solution of dilauryl peroxide in xylene were metered in over the course of 120 minutes at 110° C. After a further hour of stirring at 110° C., 36 g of a 20% strength solution of dilauryl peroxide in xylene were added and the mixture was stirred for one hour. The binder solution was cooled.

The weight-average molecular weight as determined by GPC was 19 400 g/mol; the polydispersity index was 1.9.

92.4 g of binder solution, 0.07 g of siccative (Borchers Dry 411 HS) and 7.6 g of xylene were weighed out into a 250 ml glass bottle and mixed with one another on a dissolver (10 minutes at 1500 revolutions per minute).

The coating material with added siccative was applied to a glass plate, using a 200 μm doctor knife, and dried at room temperature (23° C.). The König pendulum damping was 49 s after one day, 85 s after seven days and 127 s after one month.

Furthermore, the coating material set out above had outstanding levelling properties. Thus the waviness as measured by means of the above-stated wavescan method gave values of only 0.4 (longwave) and 2.4 (shortwave).

The coating material obtained was pigmented in accordance with the specification set out above. A coating obtained from the pigmented coating material had a hiding power of 99.67% and a gloss at 60° of 87 gloss units.

### INVENTIVE EXAMPLE 6

A 51 HWS glass reactor, equipped with Inter-MIG stirrer and reflux condenser, was charged with 3200 ml of fully demineralized water, the stirrer was set to a speed of 300 revolutions per minute, and the reactor was heated to an outside temperature of 40° C. 200 g of polyacrylic acid and 0.5 g of potassium hydrogen sulphate were added and were distributed by stirring. In a glass beaker, 605 g of methyl methacrylate, 804 g of n-butyl methacrylate, 17 g of methacrylic acid, 75 g of methacryloyloxy-2-hydroxypropyl-linoleic ester, 16 g of Peroxan LP and 32 g of ethylhexyl thioglycolate (TGEH) were mixed and homogenized with stirring. The monomer stock solution was pumped into the reactor. The internal temperature was regulated to 85° C. The polymerization was ended as soon as the evolution of heat stopped. The batch was cooled. The mother liquor was separated from the polymer beads by means of a suction filter.

The storage stability of the polymer composition obtained was determined by measurement of the molecular weight. The weight-average molecular weight as measured by GPC, immediately after preparation, was 25 000 g/mol with a polydispersity index in Mw/Mn of 1.7. After three months of storage at room temperature, the weight-average molecular weight was 24 000 g/mol and the polydispersity index was 1.8.

1. A (meth)acrylate polymer comprising:
a) 0.5 to 40% by weight of at least one unit corresponding to at least one (meth)acrylic monomer comprising at least one double bond and 8 to 40 carbon atoms;
b) 0.1 to 10% by weight of at least one unit corresponding to at least one monomer comprising at least one acid group; and
c) 50 to 99.4% by weight of at least one unit corresponding to at least one (meth)acrylate comprising 1 to 12 carbon atoms and no double bonds or heteroatoms,
wherein:
the at least one (meth)acrylate is selected such that a polymer consisting of the at least one (meth)acrylate has a glass transition temperature of at least 40° C.;
the (meth)acrylate polymer has a weight average molecular weight in the range from 10,000 to 60,000 g/mol; and
percent (%) by weight of units are, in each caseₛ based on weight of the (meth)acrylate polymer.

2. The (meth)acrylate polymer of claim 1, wherein the (meth)acrylate polymer comprises no more than 20% by weight of units corresponding to comonomers.

3. The (meth)acrylate polymer of claim 2, wherein the (meth)acrylate polymer comprises no more than 10% by weight of units corresponding to other functionalized (meth)acrylates.

4. The (meth)acrylate polymer of claim 2, wherein the (meth)acrylate polymer comprises no more than 10% by weight of units corresponding to styrene.

5. The (meth)acrylate polymer of claim 1, wherein the (meth)acrylate polymer comprises 50 to 99.4% by weight of at least one unit corresponding to methyl methacrylate and butyl methacrylate.

6. The (meth)acrylate polymer claim 5, wherein the (meth)acrylate polymer comprises 25 to 50% by weight of at least one unit corresponding to methyl methacrylate and 20 to 60% by weight of at least one unit corresponding to butyl methacrylate,

7. The (meth)acrylate polymer of claim 1, wherein the (meth)acrylate polymer comprises 0.1 to 99.4% by weight of at least one unit corresponding to at least one cycloalkyl(meth)acrylate.

8. The (meth)acrylate polymer of claim 7, wherein the (meth)acrylate polymer comprises at least one unit corresponding to an acrylate selected from the group consisting of cyclohexyl methacrylate, cyclohexyl acrylate, cyclohexyl(meth)acrylates having at least one substituent on the ring, isobornyl acrylate and isobornyl methacrylate.

9. The (meth)acrylate polymer of claim 1, wherein the (meth)acrylate polymer has a glass transition temperature in the range from 10° C. to 80° C.

10. The (meth)acrylate polymer of claim 1, wherein the (meth)acrylate polymer has a weight-average molecular weight in the range from 15,000 to 40,000 g/mol.

11. The (meth)acrylate polymer of claim 1, wherein the (meth)acrylate polymer has a polydispersity index, M_{w}/Mₙ, in the range from 1 to 10.

12. The (meth)acrylate polymer of claim 1, wherein the (meth)acrylate polymer has a molecular weight distribution with at least two maxima, measured by GPC.

13. The (meth)acrylate polymer of claim 1, wherein the (meth)acrylate polymer has an iodine number in the range from 2 to 50 g of iodine per 100 g of the (meth)acrylate polymer.

14. A coating material, comprising 10 to 80% by weight of the at least one (meth)acrylate polymer of claim 1.

15. The coating material of claim 14, wherein solids content is at least 40% by weight.

16. A method of producing a coating, comprising applying the coating material of claim 14 to a substrate and curing.

17. The method of claim 16, wherein the substrate is a metal.

18. A coated article obtainable by the method of claim 16.

19. The (meth)acrylate polymer of claim 1, wherein the (meth)acrylate polymer comprises 50 to 99.4% by weight of at least one unit corresponding to methyl methacrylate or butyl methacrylate.

20. The (meth)acrylate polymer of claim 1, wherein the (meth)acrylate polymer is suitable for preparing a coating composition.
